(19) United States
(12) Patent Application Publication
(10) Pub. No.: US 2024/0215487 A1
(43) Pub. Date: Jul. 4, 2024

(54) DISCHARGE CONTROL SYSTEM AND METHOD FOR WHEELED LAWN CARE MACHINE

(71) Applicant: Kubota Corporation, Osaka (JP)

(72) Inventors: Kirk Payne, Gainesville, GA (US); Shoichiro Nagaishi, Gainesville, GA (US)

(21) Appl. No.: 18/147,923

(22) Filed: Dec. 29, 2022

(51) Int. Cl. A01D 42/06; A01D 34/64; A01D 34/71

(52) U.S. Cl. CPC A01D 42/06; A01D 34/64; A01D 34/71

(57) ABSTRACT

A discharge control system is secured to a discharge cover over a discharge opening in a lower deck of a riding lawn mower to focus and direct an airflow exiting the discharge opening to do useful work. The system includes a discharge cover attachment and an attachment mechanism. The discharge cover attachment defines a volume and includes an exit opening which is smaller than the discharge opening. The attachment mechanism secures the discharge cover attachment to the discharge cover.

### FIELD

The present invention relates to discharge system and methods for wheeled lawn care machines, and more particularly, embodiments concern a discharge control system and method for a wheeled lawn care machine, such as a riding mower, that cooperates with an existing discharge opening to allow for capturing and directing an airflow to perform useful work.

### BACKGROUND

When performing lawn care, it may be desirable to blow leaves, grass cuttings, or other debris off of surfaces or away from structures. One solution is to employ a conventional hand-held leaf blower. This requires purchasing, transporting, and maintaining the leaf blower for when it is needed, and may not be practical for some applications, such as clearing large areas. Another solution is to mechanically strap or otherwise mount the conventional hand-held leaf blower apparatus to the front or side of a riding mower. This is not practical for some applications, including applications in which more control over the blowing function is required or the debris is located in an area where the riding mower cannot reach or cannot effectively direct the leaf blower.

This background discussion is intended to provide information related to the present invention which is not necessarily prior art.

### SUMMARY

Embodiments address the above-described and other problems and limitations in the prior art by providing a discharge control system and method for a wheeled lawn care machine, such as a riding mower, that cooperates with an existing discharge opening to allow for capturing and directing an airflow to perform useful work. For example, embodiments of the discharge control system capture and direct the airflow in a more controllable manner and so advantageously eliminate the prior art requirement to purchase, transport, and maintain a separate leaf blower apparatus while also allowing for finer control over the direction of the airflow than prior art solutions.

In an embodiment of the present invention, a wheeled lawn care machine may be provided for moving over a ground, the wheeled lawn care machine may include a drive apparatus, a lower deck, a discharge cover, and a discharge control system. The drive apparatus may be configured to propel the lawn care machine over the ground. The lower deck may be positioned below the drive apparatus and above the ground and include a discharge opening for facilitating the ejection of material from within the lower deck. The discharge cover may be positioned proximate to the discharge opening and configured to direct the ejected material. The discharge control system may be selectively attached to the discharge cover and configured to focus and direct an airflow exiting the discharge opening. The discharge control system may include a discharge cover attachment, an attachment mechanism, and a nozzle. The discharge cover attachment may define a volume and include an exit opening which is smaller than the discharge opening in the lower deck. The attachment mechanism may selectively secure the discharge cover attachment to the discharge cover. The nozzle may attach over the exit opening of the discharge cover attachment.

In various implementations, the above-described embodiment may include any one or more of the following additional or alternative features. The wheeled lawn care machine may be a riding lawn mower, and the riding lawn mower may be a zero-turn riding lawn mower. The discharge cover attachment may be selectively secured over or under the discharge cover. The nozzle may provide a straight or angled extension of the exit opening. The nozzle may have an angle of approximately between ten degrees and thirty degrees, or approximately between fifteen degrees and twenty-five degrees, or approximately twenty degrees relative to the exit opening. The angled nozzle may be selectively rotatable so as to direct the airflow in a desired direction. The discharge control system may further include a hose selectively attached to the nozzle to further extend and direct the airflow to a particular area, and the hose may have a length of approximately between four feet and six feet.

In another embodiment of the present invention, a method of moving debris using a riding lawn mower is provided. The method may include the following steps: (a) securing a discharge control system to a lower deck of the riding lawn mower proximate a discharge opening of the lower deck, (b) powering the lower deck to thereby cause airflow through the discharge opening of the lower deck and the exit opening of the discharge control system; and (c) using the airflow passing through the exit opening to move debris. The discharge control system includes a discharge attachment and an attachment mechanism. The discharge attachment defines an exit opening that is fully circumscribed by the structure of the discharge attachment. The velocity of the airflow through the exit opening of the discharge control system is at least two times greater than the velocity of the airflow through the discharge opening of the lower deck. The attachment mechanism selectively secures the discharge attachment to the lower deck.

In various implementations, the above-described embodiment may include any one or more of the following additional or alternative features. The securing of step (a) may include securing the discharge attachment to a discharge cover coupled to the lower deck proximate to the discharge opening so that the discharge attachment is secured to the lower deck via the discharge cover. The discharge control system may further comprises a nozzle positioned over the exit opening of the discharge attachment that provides an angled extension of the exit opening. The method may also include rotating the nozzle relative to the discharge attachment to thereby direct the direct airflow in a desired direction. The method may also include attaching a hose to the nozzle to further extend and direct the airflow to a particular area. The method may also include decoupling the discharge control system from the lower deck and thereafter using the riding lawn mower without the discharge control system.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a plan view of an example wheeled lawn care machine in the form of a riding mower having a lower deck;

FIG. 2 is a fragmentary view of an embodiment of a discharge control system which may be mounted to the example lawn care machine of FIG. 1;

FIG. 3 is a side elevation view of the discharge control system of FIG. 2;

FIG. 4 is a fragmentary view of the discharge control system of FIG. 2 showing an angled nozzle component rotated so as to direct an airflow in a first direction;

FIG. 5 is a fragmentary plan view of the discharge control system of FIG. 4 showing the angled nozzle component rotated so as to direct the airflow in a second direction; and

FIG. 6 is a flowchart of steps involved in a method of moving debris which may be employed with the example wheeled lawn care machine shown in FIG. 1.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

Broadly, embodiments provide a discharge control system and method for a wheeled lawn care machine, such as a riding mower, that cooperates with an existing discharge opening to allow for capturing and directing an airflow to perform useful work. Embodiments of the discharge control system capture and direct the airflow in a more controllable manner and so advantageously eliminate the prior art requirement to purchase, transport, and maintain a separate leaf blower apparatus while also allowing for finer control over the direction of the airflow than prior art solutions.

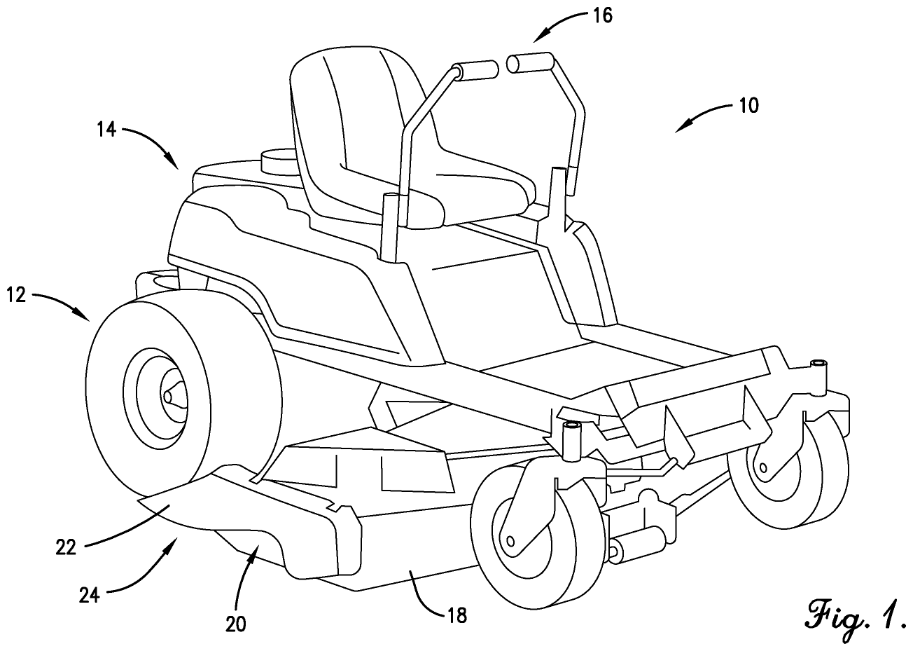

Referring to FIGS. 1-5, an embodiment of an example wheeled lawn care machine 10 for performing tasks related to lawn care (e.g., cutting or mulching) may include a plurality of wheels 12, a drive apparatus 14, a control handle 16, a lower deck 18, a discharge opening 20, a discharge cover 22, and a discharge control system 30. The plurality of wheels 12 may be substantially any suitable number, design, and configured of wheels for accomplishing the task(s) of the lawn care machine 10. In various implementations, there may be three or four wheels, and the rear wheel(s) may be larger than the front wheel(s). The drive apparatus 14 may be a combustion engine or an electric motor suitable for propelling the lawn care machine 10 over the ground and for otherwise accomplishing the task(s) of the lawn care machine 10. In one implementation, the drive apparatus 14 may drive a cutting blade (not shown) located within a volume defined by the lower deck 18. The control handle 16 may be configured to facilitate a user controlling a direction of travel of the lawn care machine 10. In various implementations, the control handle 16 may take the form of separate lever arms, as may be used in a riding lawn care machine, or a single joined handle, as may be used in a walk-behind lawn care machine. The lower deck 18 may be located below the drive apparatus 14 and configured to be normally positioned a particular distance, or within a particular range of distances, above generally flat ground during performance of the lawn care task(s). For example, the lower deck 18 may be positionable between one inch and six inches above the ground.

The discharge opening 20 may typically be provided in a sidewall of the lower deck 18 for facilitating the ejection of grass cuttings, mulched leaves, and/or other such material from within the lower deck 18. Typically, this ejection is facilitated by an airflow generated within a volume defined by the lower deck 18, such as by a spinning blade (not shown) which is powered by the drive apparatus 14. The discharge cover 22 may be positioned over, around, or otherwise proximate to the discharge opening 20 and configured to generally direct the ejected material in a sideward and/or rearward direction. Typically, the discharge cover 22 may be a three-sided plastic chute providing sufficient control over the ejection of material to prevent the material from striking nearby objects and/or otherwise being widely distributed in an uncontrolled manner and with potentially undesirable results. The discharge cover 22 may include an exit opening 24, and may generally define a chute between the discharge opening 20 and the exit opening 24, and the exit opening 24 may be substantially the same size and shape as the discharge opening 20.

In one implementation of the first embodiment, the wheeled lawn care machine may be a riding lawn mower, such as a zero-turn lawn mower, having two rear wheels, two front wheels, a combustion engine or electric motor driving a cutting blade, left and right control levers, and a lower deck partially surrounding the cutting blade and normally positioned between one and four inches above the ground. In an alternative implementation, the wheeled lawn care machine may be configured to be towed behind another vehicle, such as a lawn tractor. In this embodiment the towing vehicle may provide the control handle and the engine or motor, and power from the engine or motor may be delivered to the lawn care machine via a power takeoff connection to accomplish the lawn care task(s).

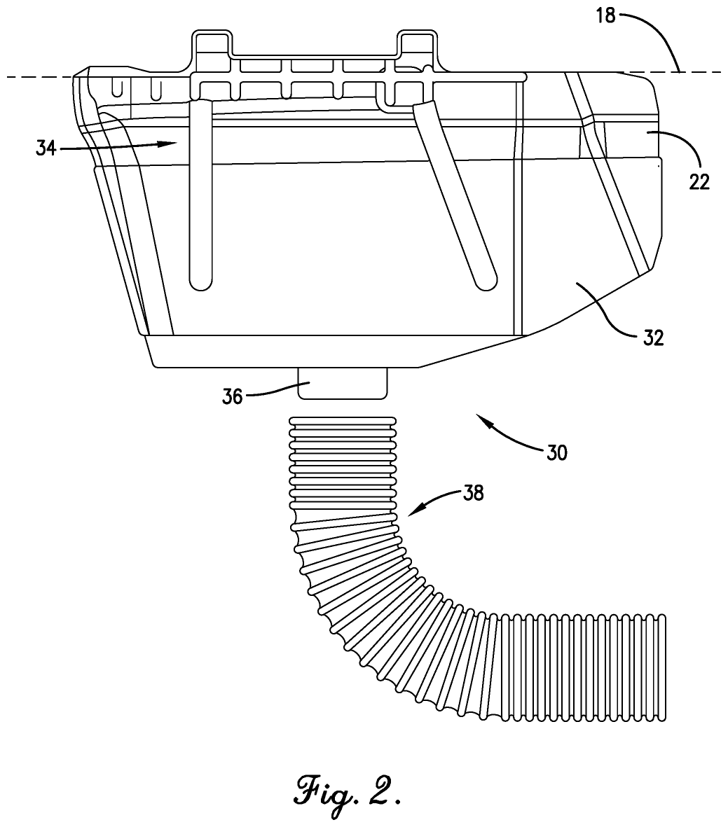

Referring particularly to FIGS. 2-5, the discharge control system 30 may be configured to selectively attach to the discharge cover 22 and focus and direct an airflow exiting the discharge opening 20 to perform useful work. An embodiment of the discharge control system 30 may include a discharge cover attachment 32, an attachment mechanism 34, a nozzle 36, and a hose 38. The discharge cover attachment 32 may be selectively securable to the existing discharge cover 22, define a volume, and include an exit opening 40 which is smaller than the discharge opening 20 (and the exit opening 24 of the chute defined by the discharge cover 22) so as to effectively accelerate, focus, and direct the airflow generated within the lower deck 18. The area defined by the exit opening 40 can be less than seventy-five percent, less than fifty percent, less than thirty-three percent, or less than twenty-five percent of the area defined by the discharge opening 20, so that the velocity of the airflow through the exit opening 40 is at least one and one-half times, two times, three times, or four times greater than the velocity of the airflow through the discharge opening 20. In one embodiment, the exit open 40 of the discharge cover attachment is surrounded on all sides (i.e., fully circumscribed) by the structure of the discharge cover attachment 32, whereas the exit opening 24 of the discharge cover 22 is not surrounded on all sides (i.e., is only partially circumscribed) by the structure of the discharge cover 22. In such an embodiment, the discharge cover 22 may be three-sided (top and two sides), with the exit opening 24 of the discharge cover 22 being open at its bottom.

In various implementations, the discharge cover attachment 32 may selectively secure over or under the discharge cover 22. The attachment mechanism 34 may be selectively engageable to secure the discharge cover attachment 32 in its normal operating position. The attachment mechanism 34 may include one or more mechanical attachments which may be constructed of substantially any suitable material, such as metal, plastic, or rubber or other elastic material, and may extend between the discharge cover attachment 32 and the discharge cover 22 and/or a surface of the lower deck 18.

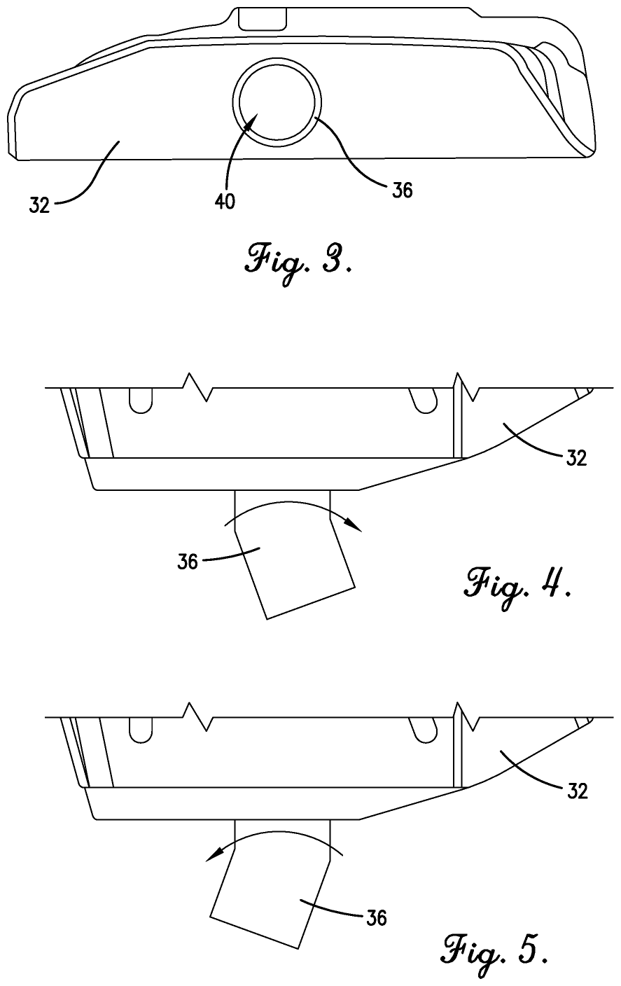

The nozzle 36 may be permanently or selectively attachable over the exit opening 40 of the discharge cover attachment 32 to further focus and direct the airflow. In various implementations, the nozzle 36 may be a substantially straight generally tubular extension of the exit opening 40 (as seen in FIGS. 2 and 3) or may be a curved or otherwise angled generally tubular extension of the exit opening 40 (as seen in FIGS. 4 and 5). In one implementation, the curved or otherwise angled nozzle 36 may be rotatable so as to allow for selectively directing the airflow in a desired direction, e.g., a generally forward or generally rearward direction, approximately between ten and thirty degrees, or approximately between fifteen and twenty-five degrees, or approximately twenty degrees relative to the exit opening 40, as seen in FIGS. 4 and 5. In one implementation, “relative to the exit opening” means relative to a line that extends through the exit opening 40 and is perpendicular to a forward orientation or direction of travel of the lawn care machine 10. The hose 38 may be selectively attachable to the nozzle 36 so as to allow for further extending and directing the airflow to a particular area to do work. The hose 38 may be of substantially any suitable design, length, and material to accomplish this purpose. In one implementation, the hose 38 may be substantially tubular in cross-sectional shape and approximately between three and seven feet, or approximately between four and six feet, or approximately five feet long.

In operation, an initial airflow may be generated within the lower deck 18, such as by a spinning blade powered by the drive apparatus 14. The airflow may flow through the discharge opening 20 in the sidewall of the lower deck 18 and into the volume defined by the discharge cover attachment 32 of the discharge control system 20. The airflow may flow through the exit opening 40 in the discharge cover attachment 32, and because the exit opening 40 is smaller than the discharge opening 20, the airflow may be accelerated, focused, and directed to better perform useful work such as blowing debris (e.g., grass cuttings, leaves, snow, trash and similar materials). The nozzle 36 may further focus and direct the airflow, including in a generally sideward, forward, or rearward direction depending on the implementation of the nozzle 36. As desired or needed, the hose 38 may be attached to the nozzle 36 to further extend and direct the airflow to a particular area, such as to an adjacent area that the airflow would not reach with sufficient force without the hose 40 being attached.

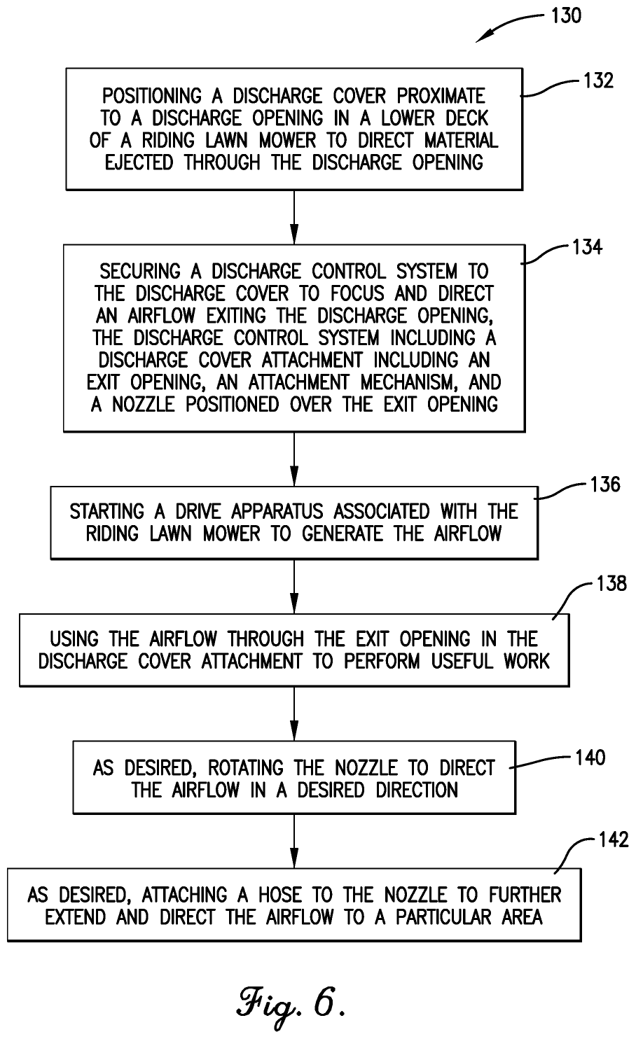

Referring also to FIG. 6, an embodiment of a discharge control method 130 may be employed with the example wheeled lawn care machine 10 described above. In one implementation, the method 130 may be implemented using the elements of the discharge control system 30 described above. Broadly, the method 130 may include the following steps.

A discharge cover may be positioned proximate to a discharge opening in a lower deck of a riding lawn mower, which may be a zero-turn riding lawn mower, to direct material ejected through the discharge opening, as shown in 132.

A discharge control system may be selectively secured to the discharge cover to focus and direct an airflow exiting the discharge opening, as shown in 134. The discharge control system may include a discharge cover attachment defining a volume and including an exit opening, the exit opening being smaller than the discharge opening in the lower deck, an attachment mechanism selectively securing the discharge cover attachment to the discharge cover, and a nozzle positioned over the exit opening of the discharge cover attachment, wherein the nozzle provides an angled extension of the exit opening. In one implementation, the nozzle may have an angle of between ten degrees and thirty degrees relative to the exit opening.

A drive apparatus associated with the riding lawn mower may be started so as to generate the airflow, as shown in 136, and the airflow through the exit opening in the discharge cover attachment may be used to perform useful work, as shown in 138, such as blowing leaves, debris, and other materials from a surface.

In one implementation, the nozzle may be selectively rotatable, and the method may include rotating nozzle to direct the airflow in a desired direction, as shown in 140.

In one implementation, the discharge control system may further include a hose selectively attachable to the nozzle, and the method may include attaching the hose to the nozzle to further extend and direct the airflow to a particular area, as shown in 142. In one implementation, the hose may have a length of between four feet and six feet.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A wheeled lawn care machine for moving over a ground, the wheeled lawn care machine comprising:
a drive apparatus for propelling the wheeled lawn care machine over the ground;
a lower deck powered by the drive apparatus and including a discharge opening for facilitating the ejection of material from within the lower deck;
a discharge cover positioned proximate to the discharge opening and directing the ejected material; and
a discharge control system selectively secured to the discharge cover and focusing and directing an airflow exiting the discharge opening, the discharge control system including—
a discharge cover attachment defining a volume and including an exit opening, the exit opening being smaller than the discharge opening in the lower deck,
an attachment mechanism selectively securing the discharge cover attachment to the discharge cover, and
a nozzle attached over the exit opening of the discharge cover attachment.

2. The wheeled lawn care machine of claim 1, wherein the wheeled lawn care machine is a riding lawn mower.

3. The wheeled lawn care machine of claim 2, wherein the riding lawn mower is a zero-turn riding lawn mower.

4. The wheeled lawn care machine of claim 1, wherein the discharge cover attachment is selectively attached over the discharge cover.

5. The wheeled lawn care machine of claim 1, wherein the discharge cover attachment is selectively attached under the discharge cover.

6. The wheeled lawn care machine of claim 1, wherein the nozzle provides a straight extension of the exit opening.

7. The wheeled lawn care machine of claim 1, wherein the nozzle provides an angled extension of the exit opening

8. The wheeled lawn care machine of claim 7, wherein the nozzle has an angle of between ten degrees and thirty degrees relative to the exit opening.

9. The wheeled lawn care machine of claim 8, wherein the nozzle has an angle of between fifteen degrees and twenty-five degrees relative to the exit opening.

10. The wheeled lawn care machine of claim 8, wherein the nozzle is selectively rotatable to direct the airflow in a desired direction.

11. The wheeled lawn care machine of claim 1, further including a hose selectively attached to the nozzle to further extend and direct the airflow to a particular area.

12. The wheeled lawn care machine of claim 11, wherein the hose has a length of between four feet and six feet.

13. A riding lawn mower for moving over a ground, the riding lawn mower comprising:
a drive apparatus for propelling the riding lawn mower over the ground;
a lower deck positioned lower than the drive apparatus and above the ground and including a discharge opening for facilitating the ejection of material from within the lower deck;
a discharge cover positioned proximate to the discharge opening and directing the ejected material; and
a discharge control system selectively secured to the discharge cover and focusing and directing an airflow exiting the discharge opening, the discharge control system including—
a discharge cover attachment defining a volume and including an exit opening, the exit opening being smaller than the discharge opening in the lower deck,
an attachment mechanism selectively securing the discharge cover attachment to the discharge cover, and
a nozzle positioned over the exit opening, wherein the nozzle provides an angled extension of the exit opening, has an angle of between ten degrees and thirty degrees relative to the exit opening, and is selectively rotatable to direct the airflow in a desired direction.

14. The riding lawn mower of claim 13, further including a hose selectively attached to the nozzle to further extend and direct the airflow to a particular area, wherein the hose has a length of between four feet and six feet.

15. A method of moving debris using a riding lawn mower, the method comprising:
(a) securing a discharge control system to a lower deck of the riding lawn mower proximate a discharge opening of the lower deck, the discharge control system including a discharge attachment and an attachment mechanism, wherein the discharge attachment defines an exit opening that is fully circumscribed by the structure of the discharge attachment, wherein the attachment mechanism selectively secures the discharge attachment to the lower deck;
(b) powering the lower deck to thereby cause airflow through the discharge opening of the lower deck and the exit opening of the discharge control system, wherein the velocity of the airflow through the exit opening of the discharge control system is at least two times greater than the velocity of the airflow through the discharge opening of the lower deck; and
(c) using the airflow passing through the exit opening to move debris.

16. The method of claim 15, wherein the securing of step (a) includes securing the discharge attachment to a discharge cover coupled to the lower deck proximate to the discharge opening so that the discharge attachment is secured to the lower deck via the discharge cover.

17. The method of claim 15, wherein the discharge control system further comprises a nozzle positioned over the exit opening of the discharge attachment and providing an angled extension of the exit opening.

18. The method of claim 17, further comprising rotating the nozzle relative to the discharge attachment to thereby direct the airflow in a desired direction.

19. The method of claim 17, further comprising attaching a hose to the nozzle to further extend and direct the airflow to a particular area.

20. The method of claim 15, further comprising decoupling the discharge control system from the lower deck and thereafter using the riding lawn mower without the discharge control system.
